(19) United States
(12) Patent Application Publication
(10) Pub. No.: US 2009/0059567 A1
(43) Pub. Date: Mar. 5, 2009

(54) DIRECT TYPE BACKLIGHT DEVICE AND OPTICAL LENS SHEET

(76) Inventor: Motoshi Uehara, Osaka (JP)

Correspondence Address: BIRCH STEWART KOLASCH & BIRCH, PO BOX 747, FALLS CHURCH, VA, 22040-0747, US

(21) Appl. No.: 12/282,096

(22) PCT Filed: Mar. 8, 2007
(86) PCT No.: PCT/JP2007/054572

§ 371 Date: Sep. 8, 2008

(30) Foreign Application Priority Data
Mar. 30, 2006 (JP) 2006-095332

(51) Int. Cl. G09F 13/04; F21V 7/22

(52) U.S. Cl. 362/97.2; 362/335

(57) ABSTRACT

An optical lens sheet 3 for use in a direct type backlight device according to the invention includes a plurality of cylindrical lenses 31 arranged in the same direction as the arrangement direction of a plurality of line light sources. The cylindrical lenses 31 each have a polygonal cross section and in the cross section of the convex surface 310, the difference between the inclination angles (θ1 to θ5) of two sides (S1 to S5) adjacent to each other gradually decreases from the lens center LC to the lens edge LE. When the distance between two line light sources arranged parallel to each other is 2L, and the height from the central axis of the line light source to the bottom surface of the optical lens sheet 3 is H, the inclination angle θ1 satisfies Expression (1). Therefore, the luminance ratio in the intermediate point between the line light sources arranged parallel to each other can be improved and a homogenous luminance distribution can be obtained.

1.6×arctan(L/H)>θ1>1.2×arctan(L/H) (1)

### TECHNICAL FIELD

The present invention relates to a direct type backlight device and an optical lens sheet, and more particularly to a direct type backlight device and an optical lens sheet for use in a liquid crystal display device such as a liquid crystal television receiver.

### BACKGROUND ART

A liquid crystal display device such as a liquid crystal television receiver includes a backlight device used to illuminate its liquid crystal panel. The backlight devices are divided into side light type and direct type devices, and direct type backlight devices capable of providing higher luminance are used in large size liquid crystal display devices having a large illumination area.

As shown in FIG. 25, a conventional direct type backlight device 100 includes a housing 101, a reflection film 105 laid on the inner surface of the housing 101, a light diffuser plate 103 fitted to an opening 102 in parallel with the backside of the housing 101, a parallel arrangement of a plurality of line light sources 104 provided parallel to the diffuser plate 103 between the reflection film 105 and the diffuser plate 103, and an optical lens sheet 106 laid on the diffuser plate 103 to control the viewing angle.

The diffuser plate 103 contains particles of barium sulfate, titanium oxide, and the like and is opaque. The diffuser plate 103 diffuses light from the line light sources 104 and the reflection film 105 and transmits the light, so that the front side luminance distribution of the direct type backlight device 100 is more homogeneous than the case without the diffuser plate 103. However, using the diffuser plate 103, light incident into the diffuser plate is repeatedly reflected and refracted by the particles contained in the diffuser plate, which reduces the quantity of light to be transmitted. The illumination efficiency of the direct type backlight device 100 is thus lowered.

In order to homogenize the luminance distribution while preventing the reduction in the illumination efficiency, direct type backlight devices disclosed by JP 10-283818 A (Patent Document 1), JP 2004-006256 A (Patent Document 2) and JP 6-250178 A (Patent Document 3) use a prism sheet including a plurality of prism lenses having a triangular cross section and arranged parallel to one another or a lenticular lens sheet including a plurality of cylindrical lenses having a cylindrical convex surface and arranged parallel to one another as a substitute for the conventional diffuser plate 103. Using the prism sheet or the lenticular lens sheet, incoming light is less repeatedly reflected and refracted than the case of using the diffuser plate 103, so that the quantity of light to be transmitted can be prevented from being reduced and the illumination efficiency can be improved.

However, the prism sheet has its limit in homogenizing the luminance distribution. While a more homogeneous luminance distribution results using the lenticular lens sheet than the prism sheet, the lenticular lens sheet suffers from luminance unevenness. The luminance ratio at the intermediate point (that corresponds to P in FIG. 25) between the line light sources (cold cathode fluorescent lamps) arranged parallel to each other is particularly smaller than the luminance ratios at any other points.

### DISCLOSURE OF THE INVENTION

It is an object of the invention to provide a direct type backlight device capable of improving the luminance ratio at the intermediate point between line light sources arranged parallel to each other and achieving a homogeneous luminance distribution.

A direct type backlight device according to the invention includes a plurality of line light sources and an optical lens sheet. The plurality of line light sources are arranged side by side. The optical lens sheet includes a base member and a plurality of cylindrical lenses. The base member is provided at a prescribed distance from the plurality of line light sources. The plurality of cylindrical lenses are formed on the base member and arranged side by side in the same direction as the arrangement direction of the plurality of line light sources. The cylindrical lens has a polygonal cross sectional shape, in the cross sectional shape, the difference between the inclination angles formed between sides adjacent to each other and a phantom line segment connecting the lens edges of the cylindrical lens gradually decreases from the lens center to the lens edge. The distance between adjacent two of the line light sources arranged parallel to one another is 2 L, and the height from the central axis of the line light source to the bottom surface of the optical lens sheet is H. The inclination angle θ1 of a side including a lens edge in the cross sectional shape satisfies Expression (1):

1.6×arctan(L/H)>θ1>1.2×arctan(L/H) (1)

Here, the base member is for example of a sheet or film type. Alternatively, the base member may be of a plate type.

In the direct type backlight device according to the invention, the inclination angle θ1 of each of the cylindrical lenses forming the optical lens sheet satisfies Expression (1). Therefore, the surface having the inclination angle θ1 in the vicinity of the lens edge can direct light incident to a point corresponding to the intermediate point between the line light sources at the bottom surface of the optical lens sheet to the front. Furthermore, at each side of the cross sectional shape of the convex surface (lens surface), the difference between the inclination angles formed by sides adjacent to each other and the phantom line segment connecting the lens edges gradually decreases from the lens center to the lens edge. More specifically, the inclination angle does not greatly change in the vicinity of the lens edge that serves to direct light incident to the intermediate point to the front. Therefore, at the convex surface, the region that allows the light incident to the intermediate point to be emitted to the front is greater than that of the conventional lenticular lens sheet. As a result, the ratio of the light incident to the intermediate point that can be emitted to the front is increased, so that the luminance ratio at the intermediate point can be increased and the luminance distribution is made more homogeneous.

A direct type backlight device according to the invention includes a plurality of line light sources and an optical lens sheet. The plurality of line light sources are arranged side by side. The optical lens sheet includes a base member and a plurality of cylindrical lenses. The base member is provided at a prescribed distance from the plurality of line light sources. The plurality of cylindrical lenses are formed on the base member and arranged side by side in the same direction as the parallel arrangement direction of the plurality of line light sources. The convex surface of the cylindrical lens has a curved cross sectional shape, and the curvature of the curve gradually decreases from the lens center to the lens edge. The distance between adjacent two of the line light sources arranged side by side is 2 L, and the height from the central axis of the line light source to the bottom surface of the optical lens sheet is H. At a lens edge of the cylindrical lens, the angle θ1 formed by the plane of the cylindrical lens and the convex surface satisfies Expression (1):

1.6×arctan(L/H)>θ1>1.2×arctan(L/H) (1)

The direct type backlight device according to the invention provides the same advantage as that brought about by the direct type backlight device described above. More specifically, in the optical lens sheet, the angle θ1 satisfies Expression (1). Therefore, the convex surface in the vicinity of the lens edge can direct light incident to the intermediate point between the line light sources at bottom surface of the optical lens sheet to the front. Furthermore, the curvature of the cross sectional shape of the convex surface gradually decreases from the lens center to the lens edge. Therefore, the region that can direct the light incident to the intermediate point to the front is greater than that by the conventional lenticular lens sheet. Consequently, the ratio of the light incident to the intermediate point that can be emitted to the front is increased, so that the luminance ratio at the intermediate point can be increased, and the luminance distribution is homogenized.

The optical lens sheet according to the invention is for use in any of the direct type backlight devices described above. Its base member preferably has optical transparency and a plate shape.

### BRIEF DESCRIPTION OF THE DRAWINGS

FIG. 1 is a perspective view of a display device including a direct type backlight device according to an embodiment of the invention;

FIG. 2 is a sectional view taken along line II-II in FIG. 1;

FIG. 3 is a cross sectional view of a cylindrical lens in the optical lens sheet in FIG. 2;

FIG. 4 is a sectional view of a direct type backlight device without a diffuser plate and an optical lens sheet;

FIG. 5 shows the luminance distribution of the direct type backlight device shown in FIG. 4;

FIG. 6 is a perspective view of a prism sheet;

FIG. 7 is a sectional view of a direct type backlight device including the prism sheet shown in FIG. 6;

FIG. 8 is the luminance distribution of the direct type backlight device shown in FIG. 7;

FIG. 9 is a view for use in illustrating the path of light emitted from a line light source in the direct type backlight device shown in FIG. 7;

FIG. 10 is a schematic view showing the path of the light shown in FIG. 9 when the light is transmitted through the prism sheet and then emitted to the outside;

FIG. 11 is a schematic view different from FIG. 10 showing the path of the light shown in FIG. 9 when the light is transmitted through the prism sheet and then emitted to the outside;

FIG. 12 is a schematic view different from FIGS. 10 and 11 showing the path of the light shown in FIG. 9 when the light is transmitted through the prism sheet and then emitted to the outside;

FIG. 13 is a schematic view different from FIGS. 10 to 12 showing the path of the light shown in FIG. 9 when the light is transmitted through the prism sheet and then emitted to the outside;

FIG. 14 is a perspective view of a lenticular lens sheet;

FIG. 15 shows the luminance distribution of a direct type backlight device including the lenticular lens sheet shown in FIG. 14;

FIG. 16 is a schematic view showing the path of light transmitted through the lenticular lens sheet shown in FIG. 14;

FIG. 17 is a schematic view for use in illustrating the condition for incoming light to an optical lens sheet according to an embodiment of the invention to be emitted to the front in the vicinity of a lens edge;

FIG. 18 is a schematic view showing the path of light from a line light source when the light is transmitted through the optical lens sheet according to the embodiment and then emitted to the outside;

FIG. 19 is a schematic view different from FIG. 18 showing the path of light from a light source when the light is transmitted through the optical lens sheet according to the embodiment and then emitted to the outside;

FIG. 20 is a schematic view different from FIGS. 18 and 19 showing the path of light from a line light source when the light is transmitted through the optical lens sheet according to the embodiment and then emitted to the outside;

FIG. 21 is a schematic view different from FIGS. 18 to 20 showing the path of light from a line light source when the light is transmitted through the optical lens sheet according to the embodiment and then emitted to the outside;

FIG. 22 shows the luminance distribution of a direct type backlight device according to the embodiment;

FIG. 23 is a sectional view of an optical lens sheet having another lens shape different from that in FIG. 3;

FIG. 24 is a schematic view for use in illustrating the lens shape of the optical lens sheet shown in FIG. 23; and

FIG. 25 is a sectional view of a conventional direct type backlight device.

### BEST MODE FOR CARRYING OUT THE INVENTION

Now, an embodiment of the invention will be described in detail with reference to the accompanying drawings in which the same or corresponding portions are denoted by the same reference characters and their description will not be repeated.

Structure of Direct Type Backlight Device

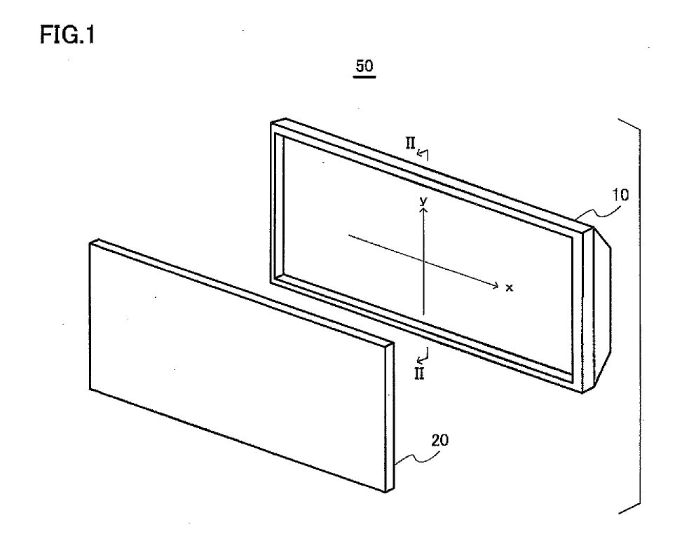

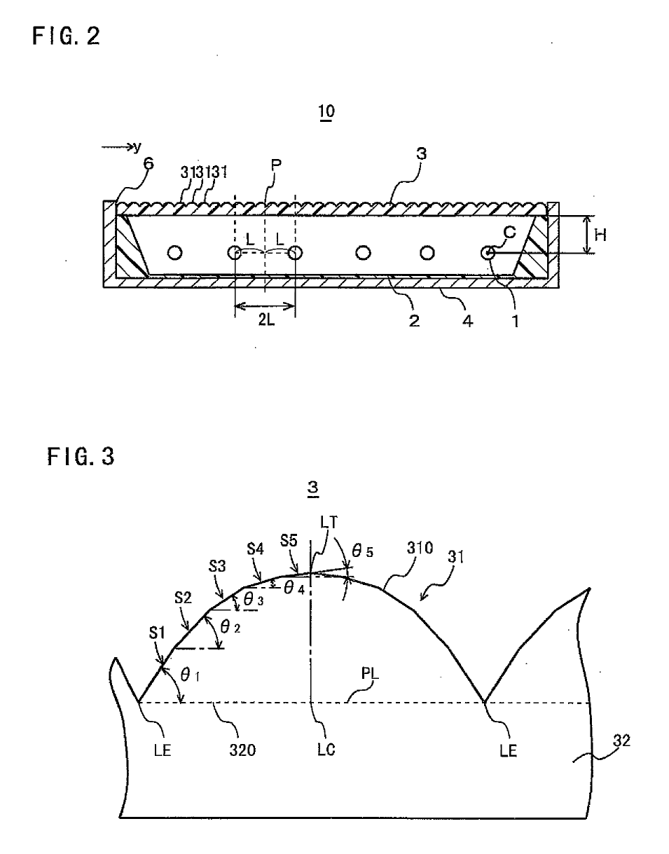

With reference to FIGS. 1 and 2, a liquid crystal display device 50 includes a direct type backlight device 10 and a liquid crystal panel 20 laid at the front of the direct type backlight device 10.

The direct type backlight device 10 includes a plurality of cold cathode fluorescent lamps 1 as line light sources, a reflection film 2, an optical lens sheet 3 capable of homogenizing luminance distribution as a substitute for a conventional diffuser plate, and a housing 4. The direct type backlight device 10 further includes a conventional optical lens sheet such as a lenticular lens sheet, a micro lens array, and a prism sheet laid on the optical lens sheet 3 for the purpose of improving the luminance and controlling the viewing angle though it is not shown in FIG. 2.

The housing 4 is a box member having an opening 6 at the front and stores the cold cathode fluorescent lamps 1 inside. The reflection film 2 is laid on the inner surface of the housing 4. The reflection film 2 randomly reflects light emitted from the cold cathode fluorescent lamps 1 and guides the light to the opening 6.

The plurality of cold cathode fluorescent lamps 1 are arranged parallel to one another in the vertical direction (the y-direction in the figures) in front of the backside of the housing 4. The cold cathode fluorescent lamps 1 are line light sources such as fluorescent tubes that extend in the horizontal direction (the x-direction in the figures).

The optical lens sheet 3 is fitted to the opening 6 and provided at a prescribed distance from the cold cathode fluorescent lamps 1. The optical lens sheet 3 includes a plurality of cylindrical lenses 31 arranged parallel to one another in the same direction as the parallel arrangement direction of the cold cathode fluorescent lamps 1. The optical lens sheet 3 directs light from the cold cathode fluorescent lamps 1 to the front of the direct type backlight device and improves the front side luminance. The optical lens sheet 3 further homogenizes the luminance distribution at the front of the direct type backlight device.

With reference to FIG. 3, the optical lens sheet 3 includes a base member 32 and a plurality of cylindrical lenses 31 formed on the base member 32. The base member 32 has optical transparency. The base member 32 may be of a sheet or film type. Alternatively, it may be of a plate type. The convex surface 310 of each of the cylindrical lenses 31 has a polygonal cross sectional shape. The difference between the inclination angles of two sides adjacent to each other among the sides S1 to S5 in the cross section of the convex surface 310 gradually decreases to the lens edge LE from the lens center LC. More specifically, the inclination angles θ1 to θ5 of the sides S1 to S5 satisfy the following Expression (A):

θ4−θ5>θ3−θ4>θ2−θ3>θ1−θ2 (A)

where an inclination angle θ is an angle formed between each side S and a phantom line segment PL connecting lens edges LE. Stated differently, it is an angle formed between the plane 320 of the cylindrical lens (i.e., the surface of the base member 32) and a surface including each side S at the convex surface 310. For example, the inclination angle θ1 is an angle formed between the plane 320 and a surface including the side S1 and the inclination angle θ2 is an angle formed between the plane 320 and a surface including the side S2.

There are five sides (S1 to S5) from the lens edge LE to the lens center LC in FIG. 3, but the number of the sides is not limited to five. When the number of sides from the lens edge LE to the lens center LC is n (S1 to Sn: n is a natural number), the inclination angle θn of each side Sn satisfies the following Expression (B):

θ(n−1)−θn>θ(n−2)−θ(n−1) (B)

In short, in the cylindrical lenses 31, the inclination angle θ in the vicinity of the lens center LC greatly changes toward the lens edges LE but the inclination angles θn of the sides in the vicinity of the lens edge LE (such as S1 and S2 in FIG. 3) do not greatly change.

Furthermore, the inclination angle θ1 of the side S1 including the lens edge LE satisfies the following Expression (1):

1.6×arctan(L/H)>θ1>1.2×arctan(L/H) (1)

where L equals a half of the distance between two cold cathode fluorescent lamps 1 arranged parallel to each other as shown in FIG. 2. As shown in FIG. 2, H is the height from the central axis C of the cold cathode fluorescent lamp 1 to the bottom surface of the lens sheet 3.

The optical lens sheet 3 including the cylindrical lenses 31 having the above-described cross sectional shape is capable of achieving more homogeneous luminance distribution than a conventional lenticular lens sheet. More specifically, among the sides Sn of the cross sectional shape of the convex surface 310, the difference between the inclination angles θn and θ(n−1) of two adjacent sides Sn and Sn−1 gradually decreases from the lens center LC to the lens edge LE, and the inclination angle θ1 of the side S1 including the lens edge LE satisfies Expression (1), so that the optical lens sheet 3 can improve the luminance ratio at the intermediate point P between the cold cathode fluorescent lamps 1 as compared to the conventional case. Therefore, the direct type backlight device 10 can provide homogeneous luminance distribution.

Now, the function of the direct type backlight device according to the embodiment will be described while comparing its luminance distribution to those at a backlight device without using a diffuser plate and an optical lens sheet, a backlight device using a prism sheet, and a backlight device using a lenticular lens sheet.

Luminance Distribution of Direct Type Backlight Device without Optical Lens Sheet

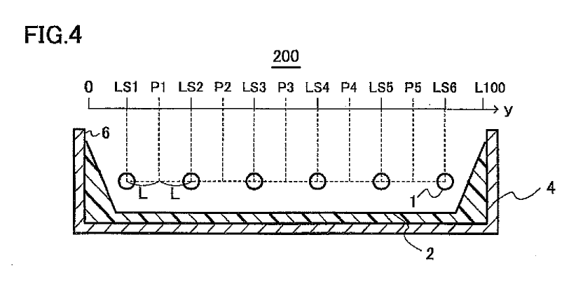

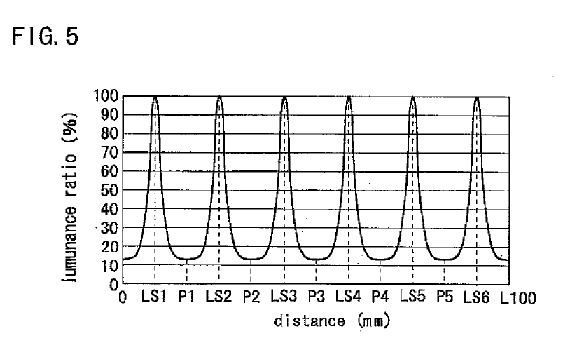

FIG. 5 shows the front side luminance distribution of a direct type backlight device 200 without a diffuser plate or an optical lens sheet as a substitute for a diffuser plate at the opening 6 as shown in FIG. 4. The abscissa in FIG. 5 represents the distance in the y-direction when the front bottom side of the direct type backlight device 200 is set as an origin (0), and the characters on the abscissa in FIG. 5 correspond to the same characters in FIG. 4. The ordinate in FIG. 5 represents the luminance ratio. The luminance ratio is the ratio of luminance in each point relative to the maximum luminance among the measured luminance values.

With reference to FIG. 5, the luminance distribution of the direct type backlight device 200 is not homogeneous. The luminance ratio is maximized at the points (LS1 to LS6) where cold cathode fluorescent lamps 1 are provided and minimized at the intermediate points (P1 to P5) between the cold cathode fluorescent lamps 1. The difference between the maximum value and the minimum value in the luminance ratio is not less than 80% and therefore luminance unevenness is generated.

Luminance Distribution of Direct Type Backlight Device Using Prism Sheet

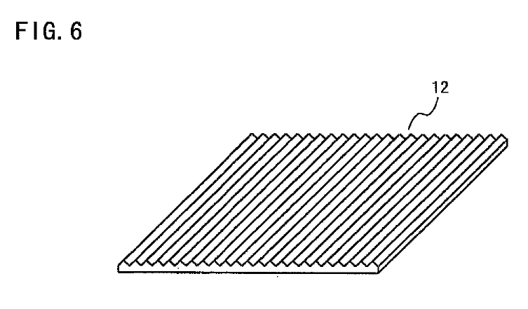

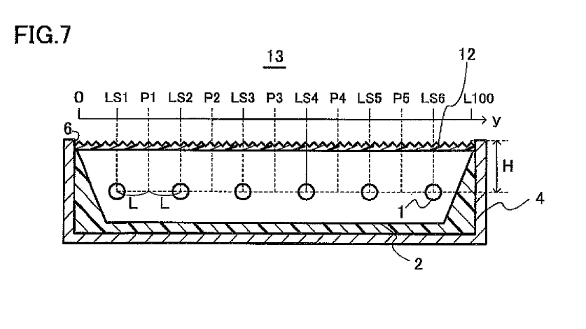

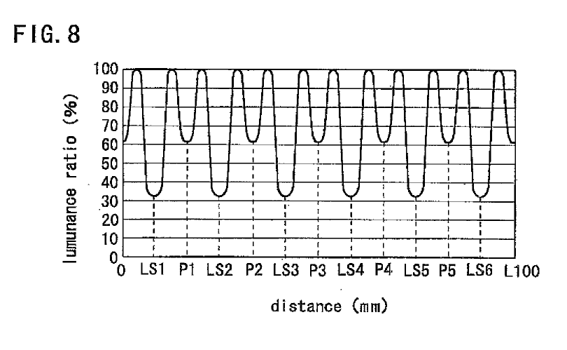

FIG. 8 shows the luminance distribution of a direct type backlight device 13 having a prism sheet 12 shown in FIG. 6 fitted to the opening 6 of the housing 4 as shown in FIG. 7. With reference to FIG. 8, the direct type backlight device 13 has its luminance ratio minimized at the points LS1 to LS6 and maximized at the points between the intermediate points P1 to P5 and the points LS1 to LS6 (such as the point between the point LS1 and the intermediate point P1). The luminance distribution is attributable to the shape of the prism lenses on the prism sheet 12. Now, this will be described.

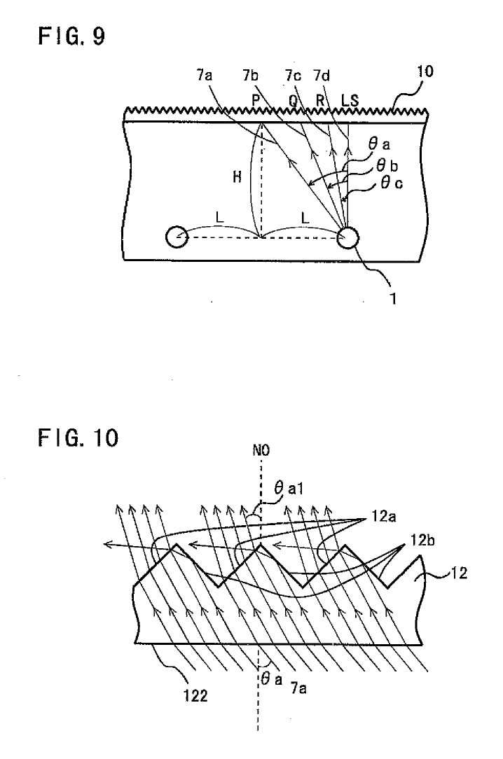

With reference to FIG. 9, the paths of light incident at various angles to the bottom surface of the prism sheet 12 from the cold cathode fluorescent lamp 1 at the point LS, i.e., the paths of light 7a at an incidence angle θa, light 7b at an incidence angle θb, light 7c at an incidence angle θc, and light 7d at an incidence angle of 0° will be described. The relation θa>θb>θc is established among the incidence angles.

The path of the light 7a incident to the intermediate point P (P1 to P5) will be described. As shown in FIG. 10, the light 7a incident at the incidence angle θa is refracted by the bottom surface of the prism sheet 12, advances in the prism sheet and then enters the prism surface 12a or 12b. The light 7a incident to the surface 12a is refracted in a direction shifted from the normal N0 by θa1″ and emitted. The light 7a incident to the surface 12b is totally reflected because its incidence angle exceeds the critical angle. The totally reflected light 7a is incident to the surface 12a and emitted to the outside at a wide angle with respect to the normal N0.

In short, the light 7a incident to the intermediate point P is emitted in a direction shifted from the front side direction (normal N0). Therefore, the luminance ratio at the intermediate point P is small.

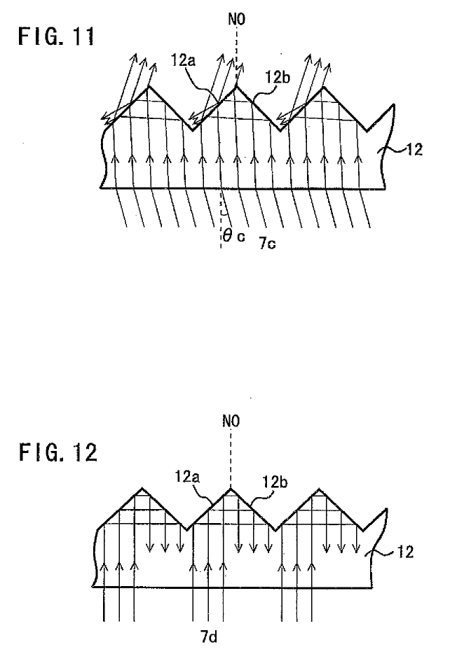

Similarly, with reference to FIG. 11, the light 7c incident at the incidence angle θc to the bottom surface of the prism sheet 12 at the point R is emitted in a direction shifted from the front side direction. Therefore, the luminance ratio at the point R is also small.

With reference to FIG. 12, at the point LS (LS1 to LS6) where each cold cathode fluorescent lamp 1 is provided, the light 7d incident to the bottom surface of the prism sheet 12 at an incidence angle of 0° is totally reflected by the prism surface 12a or 12b. More specifically, the light 7d is not transmitted through the prism surfaces 12a and 12b. Therefore, the luminance ratio at the point LS is minimized.

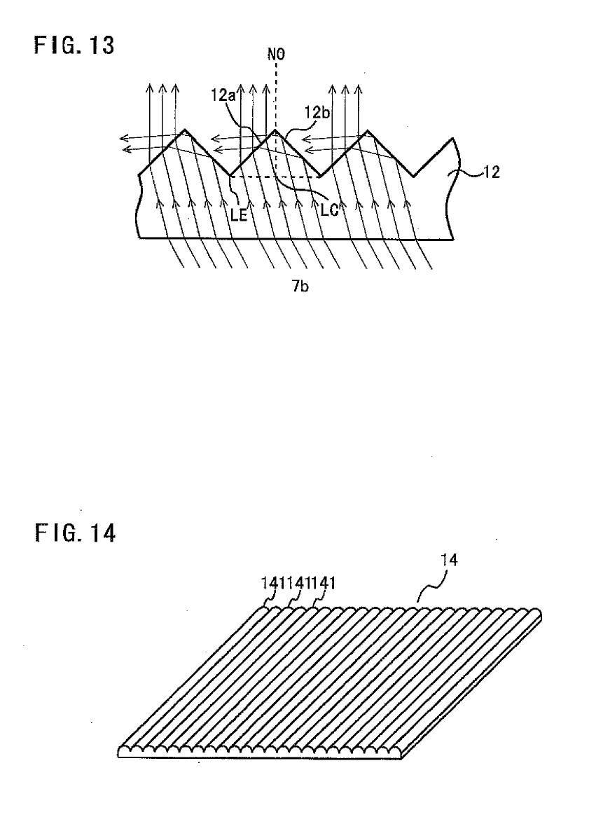

On the other hand, with reference to FIG. 13, in the light 7b incident to the prism sheet 12, the part incident to the surface 12a is emitted parallel to the normal N0 at the point Q. In the prism lens, the surface 12a has the same inclination angle from the lens edge LE to the lens center LC. Therefore, the entire light 7b incident to the surface 12a is emitted parallel to the normal N0. Consequently, the luminance ratio is maximized at the point Q.

As in the foregoing, in the prism sheet 12, while the light 7b is emitted in the direction of the normal N0 at the point Q, none of the light 7a, 7c and 7d is emitted in the direction of the normal N0 at the other intermediate point P, point LS, and point R. In short, the surfaces of the prism (12a and 12b) each have a fixed inclination angle and therefore only light incident at a particular angle is directed to the front, and the other kinds of light cannot be directed to the front. Therefore, luminance peaks are distinct as shown in FIG. 8 and a resulting luminance distribution is not homogeneous.

Luminance Distribution of Backlight Device Using Lenticular Lens Sheet

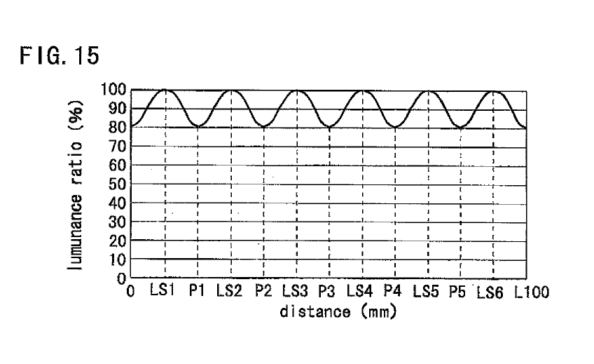

FIG. 15 shows the luminance distribution of a direct type backlight device produced by fitting a lenticular lens sheet 14 in place of the prism sheet 12 in the direct type backlight device 13 shown in FIG. 7. The lens sheet 14 includes a plurality of cylindrical lenses 141 having a circular cross sectional shape at the convex surface as shown in FIG. 14.

With reference to FIG. 15, using the lenticular lens sheet 14, the luminance distribution is more homogeneous than the case of using the prism sheet 12. However, the luminance ratio at the intermediate points P1 to P5 is about 20% lower than the luminance ratio at the points LS1 to LS6, and luminance unevenness still exists. It is considered that the luminance unevenness is generated by the following principle.

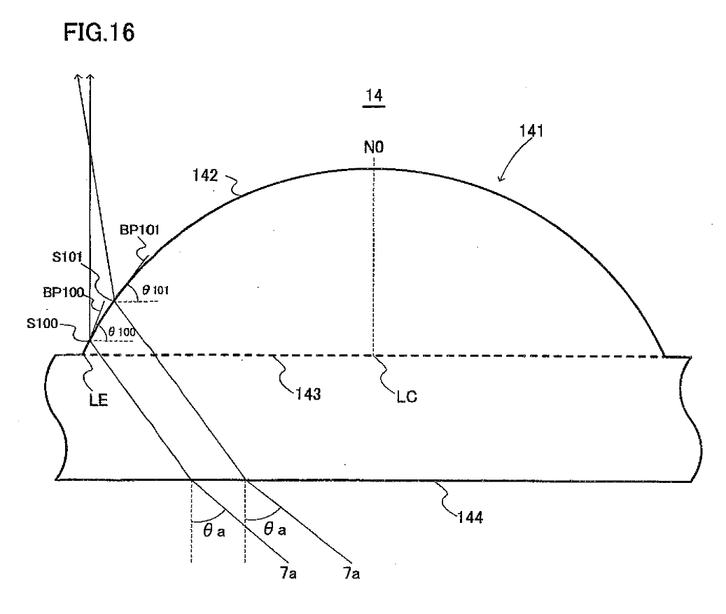

With reference to FIG. 16, the convex surface 142 of the cylindrical lens 141 has a circular cross section with a fixed curvature. When the light 7a incident to the bottom surface 144 of the lenticular lens sheet 14 at the incidence angle θa enters at the point S100 on the convex surface 142 of the cylindrical lens 141, the light 7a is emitted to the outside in parallel with the normal N0. At the time, the angle formed by the boundary plane BP100 including the point S100 and the plane 143 (referred to as “inclination angle” here) is θ100. In short, the light 7a is emitted to the front at the boundary plane BP100 that forms the inclination angle θ100.

As in the foregoing, also in the lenticular lens sheet 14, the light 7a incident to the intermediate point P can be emitted to the front. However, the region of the convex surface 142 that allows the light 7a to be emitted to the front is small. Since the convex surface 142 has a circular cross sectional shape with a fixed curvature, the inclination angle θ at the boundary plane BP including an arbitrary point S on the circle abruptly decreases from the lens edge LE to the lens center LC. More specifically, in the vicinity of the lens edge LE, the inclination angle θ greatly changes. As a result, as shown in FIG. 16, when the light 7a enters at the point S101 slightly shifted toward the lens center LC from the point S100, the inclination angle θ101 is smaller than the inclination angle θ100. Therefore, the light 7a is shifted from the normal N0 by a prescribed angle and emitted.

In short, the light 7a is emitted to the front only at the point S100 and the region in its vicinity, and is not emitted to the front if it comes into the other region. Consequently, the luminance ratio at the intermediate point P is small.

Note that the luminance ratio at the intermediate point P is reduced as the interval 2L between cold cathode fluorescent lamps 1 is larger or as the height H is smaller. In other words, as the incidence angle θa of the light 7a increases, the luminance ratio at the intermediate point P is reduced, and luminance unevenness is more distinct.

Luminance Distribution of Backlight Device Using Optical Lens Sheet According to the Invention

A direct type backlight device 10 including an optical lens sheet 3 according to the embodiment is improved about the above-described disadvantage of the lenticular lens sheet 14.

As shown in FIG. 3, in the cross sectional shape of the convex surface 310 of the cylindrical lens 31, the inclination angle θ1 of the side S1 including the lens edge LE satisfies the following Expression (1):

1.6×arctan(L/H)>θ1>1.2×arctan(L/H) (1)

Since the inclination angle θ1 satisfies Expression (1), the light 7a incident to the intermediate point P can be emitted to the front. Now, this will be described.

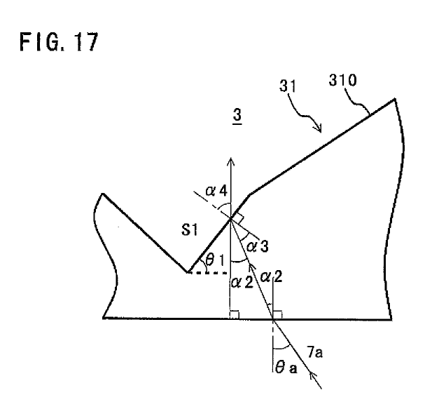

With reference to FIG. 17, the light 7a incident to the bottom surface of the optical lens sheet 3 at the incidence angle θa is emitted into the optical lens sheet 3 at a refraction angle α2. The light 7a advances in the optical lens sheet 3, then enters the side S1 in the cross sectional shape of the convex surface 310 at an incidence angle α3 and is emitted to the outside at a refraction angle α4.

When the refractive index of the optical lens sheet 3 is ns, the relation represented by the following Expressions (2) and (3) is established according to Snell's law.

sin θa=ns×sin α2 (2)

ns×sin α3=sin α4 (3)

Now, in order to direct the light 7a to the front, the following Expression (4) must be satisfied.

α2+α3=α4=θ1 (4)

The refractive index ns of a typical optical lens sheet is from 1.45 to 1.65, and therefore from Expressions (2) to (4), if the inclination angle θ1 satisfies the following Expression (5), the light 7a is emitted to the front.

1.6×θa>θ1>1.2×θa (5)

Here, the light 7a is light incident to the intermediate point P, and therefore the angle θa is represented by Expression (6):

θa=arctan(L/H) (6)

From Expressions (5) and (6), if the inclination angle θ1 satisfies Expression (1), the light 7a can be emitted to the front. Note that if the inclination angle θ1 is outside the range defined by Expression (1), the light 7a is emitted at an angle shifted from the front direction, and therefore the luminance ratio at the intermediate point P is lowered. More specifically, the difference between the luminance ratios at the point LS and the intermediate point P exceeds 10%.

Furthermore, as shown in FIG. 3, among the sides Sn of the cross sectional shape of the convex surface 310, the difference between the inclination angles of two sides adjacent to each other gradually decreases from the lens center LC to the lens edge LE. More specifically, at the sides in the vicinity of the lens edge LE that serve to collimate the light 7a (such as at S1 and S2), the inclination angle θn does not change very much. Therefore, the region of the convex surface 310 that allows the light 7a to be emitted to the front is greater than that in the cylindrical lens 141 in the lenticular lens sheet 14. As a result, the ratio of the light 7a that can be emitted to the front is greater than the case of using the lenticular lens sheet 14.

In consideration of the above-described effects, the paths of the light 7a to 7d in the direct type backlight device 10 will be described.

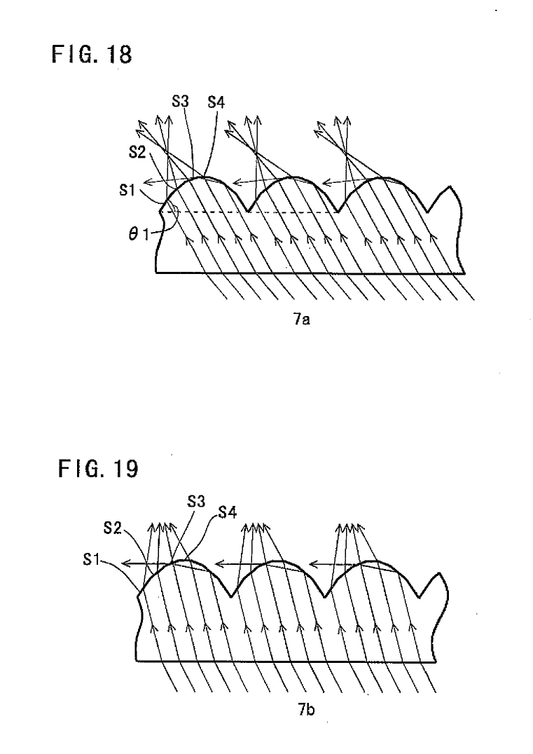

FIGS. 18 to 21 are schematic views showing the paths of the light 7a to 7d when the cylindrical lens 31 has an octagonal cross sectional shape. Note that in these figures, the cross section of the cylindrical lens 31 has an octagonal shape as an example, while any polygonal shapes other than the octagonal shape may be employed and still the same effects may be obtained.

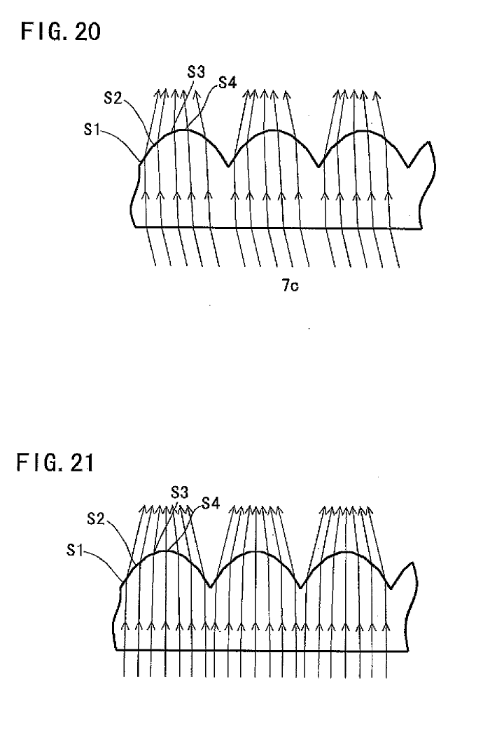

With reference to FIG. 18, in the light 7a incident to the optical lens sheet 3, the part incident to the surface corresponding to the side S1 at the inclination angle θ1 is emitted to the front. More specifically, the light 7a is partly emitted to the front. With reference to FIG. 19, in the light 7b incident to the optical lens sheet 3, the part incident to the surface corresponding to the side S2 is emitted to the front. Therefore, the light 7b is partly collimated to the front direction. Similarly, with reference to FIGS. 20 and 21, the part of the light 7c incident to the surface corresponding to the side S3 is emitted to the front, and the part of the light 7d incident to the surface corresponding to the side S4 is emitted to the front.

As in the foregoing, when the optical lens sheet 3 is used, part of each of the light 7a to 7d is emitted to the front. Light having a greater incidence angle to the optical lens sheet 3 is less likely to be emitted to the front while in the cylindrical lens 31 of the optical lens 3, the inclination angle θ1 that allows the light 7a to be emitted to the front is at the lens edge LE, and the inclination angle does not change very much at the sides in the vicinity of the lens edge LE. Therefore, the ratio of the light 7a that can be emitted to the front can be increased, and the luminance ratio at the intermediate point P can be increased to a level substantially equal to the luminance ratios at the other points.

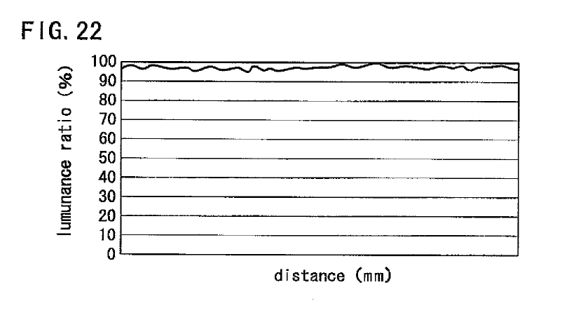

FIG. 22 shows the luminance distribution of the direct type backlight device 10. FIG. 22 shows as an example a luminance distribution obtained using an optical lens sheet 3 including cylindrical lenses 31 in which the cross section of the convex surface 310 from the lens edge LE to the lens center LC includes four sides (S1 to S4). Note that in the cylindrical lens in the optical lens sheet used for examining the luminance distribution, the inclination angle θ1 of the side S1 was 60°, the inclination angle θ2 of the side S2 was 50°, the inclination angle θ3 of the side S3 was 30°, and the inclination angle θ4 of the side S4 was 5°, so that Expression (B) was satisfied. The interval 2L between the line light sources was 36 mm and the height H was 18 mm, so that Expression (1) was satisfied.

With reference to FIG. 22, the luminance distribution is more homogeneous than that of the direct type backlight device using the lenticular lens sheet 14, and the difference between the maximum value and the minimum value in the luminance ratio is less than 10%.

Other Forms of Optical Lens Sheet

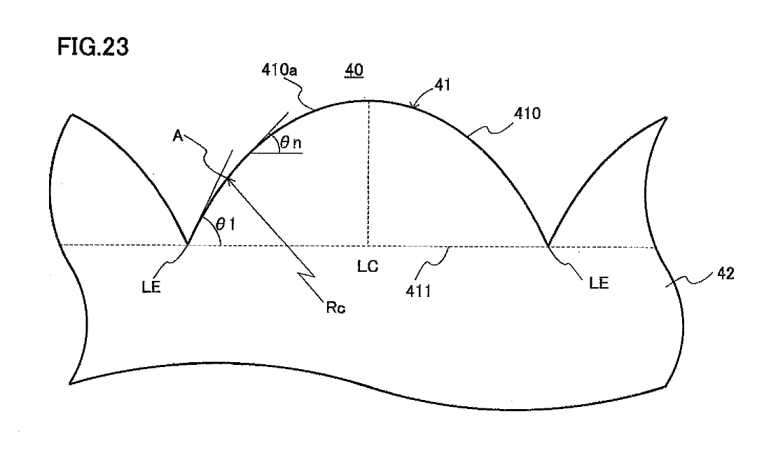

FIG. 23 shows an optical lens sheet 40 having a structure different from the optical lens sheet 3 shown in FIG. 3. With reference to FIG. 23, the optical lens sheet 40 includes a base member 42 and a plurality of cylindrical lenses 41 formed on the base member 42. The base member 42 has optical transparency. The base member 42 may be of a sheet or film type. It may be a plate type member. The plurality of cylindrical lenses 41 are arranged parallel to one another in the same direction as the parallel arrangement direction of cold cathode fluorescent lamps 1.

The convex surface 410 of the cylindrical lens 41 has an arcuate curve in cross section. The curvature CU defined by the following Expression (7) gradually decreases from the lens center LC to the lens edge LE.

CU=1/Rc (7)

where Rc is a radius of curvature at an arbitrary point A on the curve of the cross sectional shape of the convex surface 410.

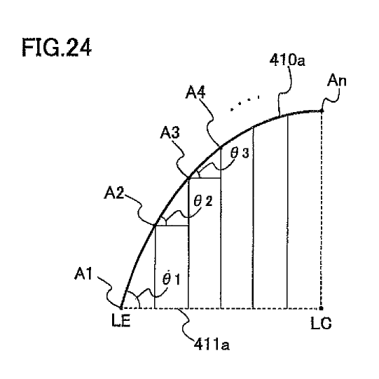

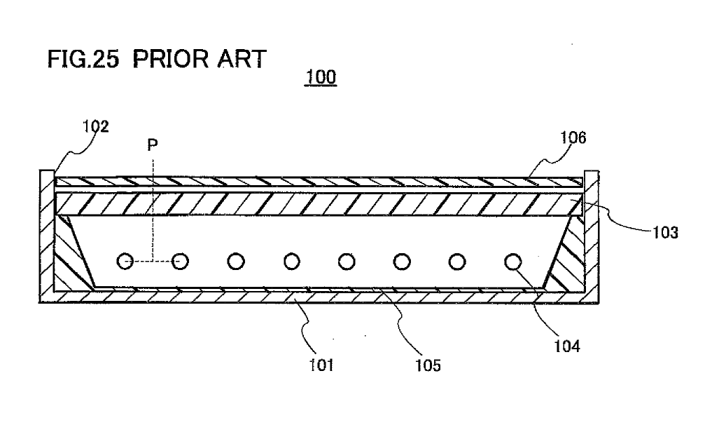

This is equivalent to the following aspect. With reference to FIG. 24, the curve 410a between the lens edge LE and the center LC is equally divided in the direction parallel to the cross sectional shape 411a (that is a straight line) of the plane 411 of the cylindrical lens 41. If the angles formed by convex surfaces at divisional points A1 to An and a plane parallel to the plane 411 are θ1 to θn, the angles θ1 to θn satisfy the following Expression (B). In short, if the number of sides Sn in the cross sectional shape of the convex surface 310 in FIG. 3 is infinite, the convex surface 410 shown in FIG. 23 results.

Furthermore, the angle θ1 described above, i.e., the angle formed by the convex surface 410 and the plane 411 at the lens edge LE satisfies Expression (1).

In this way, the optical lens sheet 40 provides the same effects as those by the optical lens sheet 3. More specifically, it has the angle θ1 that allows the light 7a incident to the intermediate point P to be emitted to the front and the curvature gradually decreases at the convex surface 410 from the lens center LC to the lens edge LE. Stated differently, the angle θn in the vicinity of the lens edge LE does not greatly change and the angle θn more greatly changes toward the lens center LC. Therefore, the region that allows the light 7a to be emitted to the front can be larger than the case of using the lenticular lens sheet, so that the luminance ratio at the intermediate point P may be increased to a level substantially equal to the luminance ratios at the other points.

Manufacturing Method

A method of manufacturing the optical lens sheet 3 shown in FIG. 3 will be described.

To begin with, the interval 2L between cold cathode fluorescent lamps 1 provided parallel to one another in a direct type backlight device 10 using the optical lens sheet 3 shown in FIG. 3 and the height H from the central axis C of the cold cathode fluorescent lamp 1 to the bottom surface of the optical lens sheet 3 are determined.

After the interval 2L and the height H are determined, the inclination angle θ1 is determined based on the determined interval 2L and height H and Expression (1).

After the inclination angle θ1 is determined, the lens shape of the cylindrical lens 31 is determined based on the determined inclination angle θ1 so that the difference between the inclination angles θn and θ(n−1) of two sides Sn and Sn−1 adjacent to each other in the cross sectional shape of the convex surface 310 of the cylindrical lens 31 gradually decreases from the lens center LC to the lens edge LE.

After the lens shape is thus determined, a roll plate having grooves with the same cross sectional shape as that of the cylindrical lenses 31 is produced. Using the produced roll plate, an optical lens sheet 3 including the plurality of cylindrical lenses 31 is produced.

According to the above-described manufacturing method, the roll plate is used in the manufacture, while after determining the lens shape, the optical lens sheet 3 may be produced by other methods without using the roll plate. For example, when a plate shaped optical lens sheet 3 is produced, a flat plate (flat die) having a plurality of grooves corresponding to the cylindrical lenses 31 may be used. In this case, the grooves in the flat plate are filled with thermoplastic resin, ionizing radiation curing resin or the like, and a substrate to serve as a base member 32 is laid thereon. The thermoplastic resin or the ionizing radiation curing resin is cured to form the cylindrical lenses 31, and the optical lens sheet 3 is thus produced. Note that the ionizing radiation curing resin is resin cured by ionizing radiation such as ultraviolet and electron beam radiation.

The optical lens sheet 40 shown in FIG. 23 can be produced by the same method as the optical lens sheet 3. More specifically, the interval 2L and the height H are determined, and then the angle θ1 is determined based on the determined interval 2L and height H and Expression (1). After determining the angle θ1, the lens shape of the cylindrical lens 41 is determined so that the curvature of the cross sectional shape (curve) of the convex surface 410 of the cylindrical lens 41 gradually decreases from the lens center LC to the lens edge LE.

By the foregoing manufacturing method, the optical lens sheets 3 and 40 can be produced.

Note that the interval 2L and the height H are generally determined so that the incidence angle θa of the light 7a to the intermediate point P is from 15° to 50°, while even if the incidence angle θa exceeds the above-described range, the above-described effects can be obtained in the optical lens sheet according to the embodiment.

The interval 2L between the cold cathode fluorescent lamps 1 is preferably from 10 μm to 500 μm. If it is less than 10 μm, it is difficult to form the cylindrical lenses, and if it is above 500 μm, the effect of homogenizing the luminance distribution is reduced. However, even outside the above-described range, the effects of the invention can be obtained to some extent.

According to the embodiment, the plurality of cold cathode fluorescent lamps 1 are provided parallel to one another in the vertical direction (the y-direction in FIG. 1) in front of the backside of the housing 4 in FIGS. 1 and 2, while the cold cathode fluorescent lamps 1 may be arranged parallel to one another in the horizontal direction (the x-direction in FIG. 1).

The cylindrical lens 31 on the optical lens sheet 3 according to the embodiment may have its lens edge LE in contact with the lens edge LE of another adjacent cylindrical lens 31, or the lens edges LE may be arranged at a prescribed distance without being in contact with each other. This also applies to the optical lens sheet 40.

Although the embodiment of the present invention has been described, the same is by way of illustration and example only. Therefore, the invention is not limited by the above-described embodiment and may be embodied in various modified forms without departing from the spirit and scope of the invention.

1. A direct type backlight device, comprising:
a plurality of line light sources arranged side by side; and
an optical lens sheet including a base member provided at a prescribed distance from said plurality of line light sources and a plurality of cylindrical lenses formed on said base member and arranged in the same direction as the arrangement direction of said plurality of line light sources,
said cylindrical lens having a polygonal cross sectional shape, in said cross sectional shape, the difference between the inclination angles formed between sides adjacent to each other and a phantom line segment connecting the lens edges of said cylindrical lens gradually decreasing from the lens center to the lens edge,
the distance between adjacent two of said line light sources arranged side by side being 2L, the height from the central axis of said line light source to the bottom surface of said optical lens sheet being H,
in said cross sectional shape, the inclination angle θ1 of a side including a lens edge satisfying Expression (1):
1.6×arctan(L/H)>θ1>1.2×arctan(L/H) (1)

2. A direct type backlight device, comprising:
a plurality of line light sources arranged side by side; and
an optical lens sheet including a base member provided at a prescribed distance from said plurality of line light sources and a plurality of cylindrical lenses formed on said base member and arranged in the same direction as the arrangement direction of said plurality of line light sources,
the convex surface of said cylindrical lens having a curved cross sectional shape, the curvature of said curve being gradually reduced from the lens center to the lens edge,
the distance between adjacent two of said line light sources arranged side by side being 2L, the height from the central axis of said line light source to the bottom surface of said optical lens sheet being H,
at a lens edge of said cylindrical lens, the angle θ1 formed by the plane of said cylindrical lens and said convex surface satisfying Expression (1):
1.6×arctan(L/H)>θ1>1.2×arctan(L/H) (1)

3. The direct type backlight device according to claim 1, wherein said base member has optical transparency and a plate shape.

4. An optical lens sheet for use in a direct type backlight device having a plurality of line light sources arranged side by side, comprising:
a base member arranged at a prescribed distance from said plurality of line light sources; and
a plurality of cylindrical lenses formed on said base member and arranged in the same direction as the arrangement direction of said plurality of line light sources,
said cylindrical lens having a polygonal cross sectional shape, in said cross sectional shape, the difference between the inclination angles formed by sides adjacent to each other and a phantom line segment connecting the lens edges of said cylindrical lens gradually decreasing from the lens center to the lens edge,
the distance between adjacent two of said line light sources arranged parallel side by side being 2L, the height from the central axis of said line light source to the bottom surface of said optical lens sheet being H,
in said cross sectional shape, the inclination angle θ1 of a side including a lens edge satisfying Expression (1):
1.6×arctan(L/H)>θ1>1.2×arctan(L/H) (1)

5. An optical lens sheet for use in a direct type backlight device having a plurality of line light sources arranged side by side, comprising:
a base member arranged at a prescribed distance from said plurality of line light sources; and
a plurality of cylindrical lenses formed on said base member and arranged parallel in the same direction as the arrangement direction of said plurality of line light sources,
the convex surface of said cylindrical lens having a curved cross sectional shape, the curvature of said curve gradually decreasing from the lens center to the lens edge,
the distance between adjacent two of said line light sources arranged parallel side by side being 2L, the height from the central axis of said line light source to the bottom surface of said optical lens sheet being H,
the angle θ1 formed by the plane of said cylindrical lens and said convex surface at the lens edge of said cylindrical lens satisfying Expression (1):
1.6×arctan(L/K)>θ1>1.2×arctan(L/H) (1)

6. The optical lens sheet according to claim 4, wherein said base member has optical transparency and a plate shape.

7. The direct type backlight device according to claim 2, wherein said base member has optical transparency and a plate shape.

8. The optical lens sheet according to claim 5, wherein said base member has optical transparency and a plate shape.
